(19) United States
(12) Patent Application Publication
(10) Pub. No.: US 2026/0206674 A1
(43) Pub. Date: Jul. 23, 2026

(54) SPROUTER DEVICE

(71) Applicant: WoVa Labs, Inc., Twentynine Palms, CA (US)

(72) Inventors: Douglas Evans, Twentynine Palms, CA (US); Paul Naddaff, Newton, MA (US); Ashley Legg, Düsseldorf (DE)

(21) Appl. No.: 19/570,756

(22) Filed: Mar. 18, 2026

Related U.S. Application Data
(63) Continuation-in-part of application No. PCT/US24/45831, filed on Sep. 9, 2024.
(60) Provisional application No. 63/539,259, filed on Sep. 19, 2023.

(51) Int. Cl. A01C 1/02

(52) U.S. Cl. CPC A01C 1/02

(57) ABSTRACT

A sprouter device may include a container with an open end, a porous filter to fit over the open end of the container, a collar to secure the porous filter flush over a lip of the open end of the container, and a stand. The stand may include an arm that includes a receiver in which the container may be placed, and a base, wherein the arm may be removably coupled to the base. The receiver may include one or more contacts positioned within an interior of the receiver that may contact the container when the container is positioned within the receiver.

### INCORPORATION BY REFERENCE TO ANY PRIORITY APPLICATIONS

This application is a continuation-in-part application of International Patent Application No. PCT/US24/45831 filed on Sep. 9, 2024, which claims the benefit of U.S. Provisional Application No. 63/539,259, filed Sep. 19, 2023, the entire contents of each of which are hereby incorporated by reference in their entirety.

### BACKGROUND

The disclosure relates generally to devices for sprouting seeds.

### SUMMARY

For purposes of summarizing the disclosure and the advantages achieved over existing sprouting devices, certain objects and advantages of the disclosure are described herein. Not all such objects or advantages may be achieved in any particular embodiment. Thus, for example, those skilled in the art will recognize that techniques may be embodied or carried out in a manner that achieves or optimizes one advantage or group of advantages as taught herein without necessarily achieving other objects or advantages as may be taught or suggested herein.

In some aspects, an integrated sprouter device is provided. The integrated sprouter device includes a container with an open end, a porous filter to fit over the open end of the container, a collar to secure the porous filter flush over a lip of the open end of the container, and a stand. The stand includes an arm that includes a recess or an opening in which the container is placed, and a base, wherein the arm meets the base at an angle.

In some embodiments, the container is straight-walled. In some embodiments, the pores of the porous filter extend over a lip of the open end of the container. In some embodiments, the pores of the porous filter are flush against the lip of the open end of the container. In some embodiments, the opening includes a through-hole through which the container is to be inserted. In some embodiments, the arm includes a wedge and the container is to rest in the recess of the wedge. In some embodiments, the arm includes a cradle and the container is to rest in the recess of the cradle. In some embodiments, the angle is between 20 and 60 degrees.

Any of the features of an aspect is applicable to all aspects identified herein. Moreover, any of the features of an aspect is independently combinable, partly or wholly with other aspects described herein in any way, e.g., one, two, or three or more aspects may be combinable in whole or in part. Further, any of the features of an aspect may be made optional to other aspects. Any aspect of a method can comprise another aspect of a system. Furthermore, any aspect of a system can be configured to perform a method of another aspect.

In some aspects, a sprouter device includes: a stand including: a base; an arm including a proximal end and a distal end, the proximal end of the arm configured to be coupled to the base; and a receiver at the distal end of the arm, the receiver configured to receive a container.

In some aspects, the arm is configured to be coupled to the base via a hinge and snap mechanism. In some aspects, the proximal end of the arm includes a plurality of male snap joint features, and the base includes a plurality of female snap joint features configured to engage with the plurality of male snap joint features of the arm. In some aspects, the proximal end of the arm includes a plurality of tabs, and the base includes a plurality of slots configured to receive the plurality of tabs of the arm. In some aspects, the receiver includes a ring. In some aspects, the receiver includes a plurality of contacts positioned within an interior of the ring, the plurality of contacts configured to contact the container when the container is positioned within the receiver. In some aspects, one or more of the plurality of contacts extend along an interior of a wall of the receiver. In some aspects, one or more of the plurality of contacts taper along an interior of a wall of the receiver. In some aspects, the base includes a docking area configured to receive the container. In some aspects, the docking area includes a rim configured to extend at least partially around the container when the container is positioned on the docking area. In some aspects, the arm includes a first portion of the rim and the base includes a second portion of the rim. In some aspects, the base includes a docking area and a capture tray area, and a bottom of the base includes a first plurality of fins extending around a bottom of the docking area and a second plurality of fins extending around a bottom of the capture tray area. In some aspects, the base includes a capture tray area configured to receive a capture tray. In some aspects, the capture tray area is configured to receive the capture tray such that the arm suspends the container above the capture tray when the container is positioned within the receiver of the arm. In some aspects, the capture tray area includes a through-hole through the base. In some aspects, the capture tray area includes a rim configured to extend at least partially around the capture tray when the capture tray is positioned on the capture tray area. In some aspects, the stand includes 30% glass-filled ABS material. In some aspects, the techniques described herein relate to a sprouter device, further including a capture tray, wherein the capture tray includes a volume of approximately 350 mL. In some aspects, the techniques described herein relate to a sprouter device, further including: a container configured to be positioned within the stand; and a porous filter configured to be positioned over an open end of the container, wherein the porous filter includes a plurality of holes on a central portion of the porous filter and a plurality of slots extending radially outwards. In some aspects, the porous filter includes a first annular region surrounding the central portion and a second annular region surrounding the first annular region, and wherein the central portion is convex, the first annular region is concave, and the second annular region is flat.

### BRIEF DESCRIPTION OF THE DRAWINGS

FIG. 1 is a perspective view illustration of an integrated sprouter device, according to some embodiments.

FIG. 2 is a perspective view illustration of a container, a porous filter, and a collar of the integrated sprouter device, according to some embodiments.

FIG. 3 is a cross-sectional illustration of the integrated sprouter device of FIG. 2, according to some embodiments.

FIG. 4A is a side view illustration of the container, according to some embodiments.

FIG. 4B is a cross-sectional illustration of the container of FIG. 4A, according to some embodiments.

FIGS. 5A-5C are illustrations of the porous filter, according to some embodiments.

FIG. 6 is a perspective view illustration of a stand of the integrated sprouter device, according to some embodiments.

FIG. 7A is a perspective view illustration of a sprouter device according to another embodiment.

FIG. 7B is a perspective view illustration of the stand of FIG. 7A, with the arm of the stand separated from the base of the stand.

FIGS. 8A-8C are perspective view illustrations of the stand of FIGS. 7A-7B, with the arm of the stand being coupled to the base of the stand.

FIG. 9A is a perspective view illustration of the stand of FIGS. 7A-8C.

FIG. 9B is a perspective view illustration of the stand of FIG. 9A, with a container being positioned therein.

FIG. 10A is a perspective view illustration of the stand of FIGS. 7A-9B, with the container positioned on a docking area of the stand.

FIG. 10B is a perspective view illustration of the stand of FIG. 10A, without the container positioned on the docking area.

FIG. 10C is a perspective view illustration of the stand of FIG. 10A, with the arm of the stand separated from the base of the stand.

FIG. 11 is a lower end view illustration of the stand of FIGS. 7A-10C.

FIG. 12A is a perspective view illustration of the stand of FIGS. 7A-11, with a capture tray positioned thereon.

FIG. 12B is a perspective view illustration of the stand of FIG. 12A, without the capture tray positioned thereon.

FIG. 13A is a perspective view illustration of a porous filter, according to another embodiment.

FIG. 13B is a side, section view illustration of the porous filter of FIG. 13A.

FIG. 13C is a perspective view illustration of a container, with the porous filter of FIG. 13A positioned thereon.

### DETAILED DESCRIPTION

A detailed description of one or more embodiments of the present disclosure is provided below along with accompanying figures that illustrate the principles of the present disclosure. The present disclosure is described in connection with such embodiments, but the present disclosure is not limited to any embodiment. The present disclosure encompasses numerous alternatives, modifications and equivalents. Numerous specific details are set forth in the following description in order to provide a thorough understanding of the present disclosure. These details are provided for the purpose of example and the present disclosure may be practiced according to the claims without some or all of these specific details.

Seeds require moisture and airflow to successfully sprout. Conventionally, to aid in the sprouting of seeds, water is added to seeds in a container to moisten the seeds. The water is then drained out of the container. However, the process of draining the container may result in seeds inadvertently spilling out and/or residual water being left in the container. The residual water could also foster bacterial growth, which would render the sprouts unsuitable for human consumption.

Embodiments of an integrated sprouter device are described herein. In various embodiments, the integrated sprouter device comprises one or more of the following components: a container, a porous filter, a collar, and a stand. In some embodiments, the container has one opening. For example, seeds and water can be deposited into the container through the opening. In some embodiments, the porous filter can fit over the opening of the container. At least some pores (e.g., slots) of the filter extend over and are flush against the lip of the opening of the container to allow for water to fully drain out of the container. In some embodiments, the collar comprises a ring that fits around the opening of the container and engages/couples with the exterior surface of the container near the opening. In some embodiments, after the filter is placed over the opening of the container, the collar is then placed over the filter and then engaged with the (e.g., threading features of the) exterior surface of the container to thereby lock/clamp the filter in place over the opening of the container. After engaging the collar over with the exterior surface of container near the opening, the opening of the container can be pointed downwards to allow water to drain out of the container through the filter. In various embodiments, the collared end of the filter-covered container is then inserted into a stand which will engage with the collar of the container and hold the container at an angle relative to the plane on which the stand rests. The stand will suspend the filter-covered opening of the container to drain water into a water capture tray such that the container can be fully drained without human intervention and allow the moistened seeds within the container to successfully sprout without residual water that could result in potential, undesirable bacterial growth.

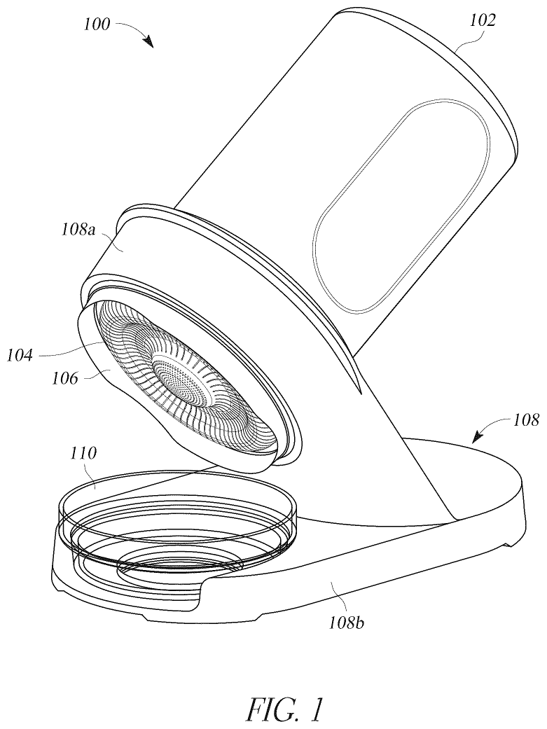

FIG. 1 is a diagram showing an example integrated sprouter device in accordance with some embodiments. As shown in FIG. 1, integrated sprouter device comprises container 102, porous filter 104, collar 106, stand 108, and water capture tray 110. Seeds and water can be added to container 102, for example while the open end of container 102 is upright. For example, the seeds can be soaked in the water for at least a prescribed length of time before the water is desired to be drained from container 102. When the water is desired to be drained from container 102, porous filter 104 is placed over the open end of container 102 (like an end cap) and then collar 106 is placed over porous filter 104 and then engaged with the engagement features (e.g., threads) located on the exterior surface of container 102. After porous filter 104 and collar 106 are secured at the open end of container 102, that collared end of container 102 is inserted into the angled ring opening of stand 108. The diameter of the ring opening of stand 108 is such that the collared end of container 102 is locked within the ring opening and that container 102 does not fully pass through. Arm 108a of stand 108 that includes the ring opening is at an angle relative to base 108b of stand 108 so as to allow water to drain through porous filter 104 into water capture tray 110. In some embodiments, water capture tray 110 is a removable tray that can be inserted into a cavity or through-hole of a corresponding shape in the base of stand 108 so that it can be cleaned. For example, arm 108a of stand 108 is angled between 20 to 60 degrees. Specifically, the angle can be 35 degrees. One advantage to angling the arm of stand 108 is to allow water to drain from container 102 but also prevent the seeds and eventual sprouts within container 102 from fully covering porous filter 104, which would prevent desired airflow from pass in and out of container 102. For example, if arm 108a were parallel to base 108b of stand 108 (and presuming that base 108b is placed on a plane parallel to the ground), then the seeds and/or sprouts within container 102 could completely cover porous filter 104 and obstruct airflow in and out of container 102, which would be a safety risk. Collar 106 and porous filter 104 are suspended at a distance/airgap above water capture tray 110 such that the used water that drips out of container 102 will not touch and potentially contaminate the seeds and/or sprouts within container 102. In some embodiments, the exterior surface of collar 106 includes protruding features (e.g., ribs) that introduce friction between collar 106 and the internal surface of the ring opening of arm 108a of stand 108. This amount of friction may still allow container 102 to rotate within the ring opening of stand 108.

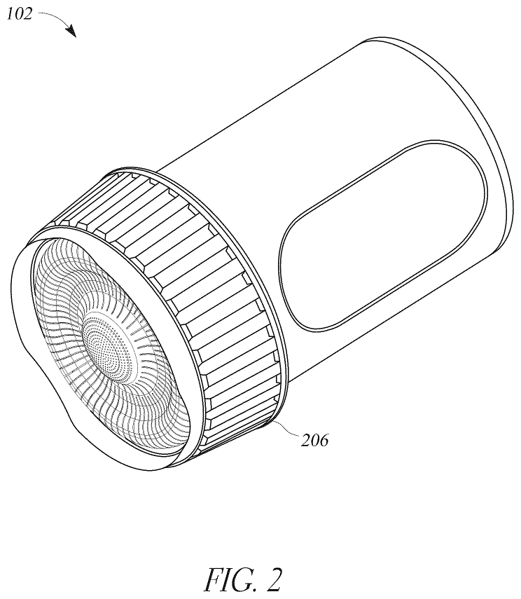

FIG. 2 is a diagram showing an example of a container, a porous filter, and a collar of the integrated sprouter device in accordance with some embodiments. In some embodiments, container 102 and collar 106 of FIG. 1 may be implemented using the example container and collar of FIG. 2. As mentioned above, in some embodiments, collar 206 includes features on its exterior surface that creates friction against the interior surface of the ring opening of the stand (not shown) of the integrated sprouter device. In the example of FIG. 2, collar 206 includes ribs along its exterior surface. The dimensions of the ribs along the exterior surface of collar 206 introduce an amount of friction that secures collar 206 but still allows container 102 to be easily removed from the stand (not shown in FIG. 2) by the user with one hand, without requiring the user's other hand to hold the stand in place. For example, a user may want to rotate the container and collar 206 within the ring opening of the stand to distribute seeds/sprouts within the container and/or to release more water from the container into the water capture tray (not shown). In various embodiments, the collar is made of plastic.

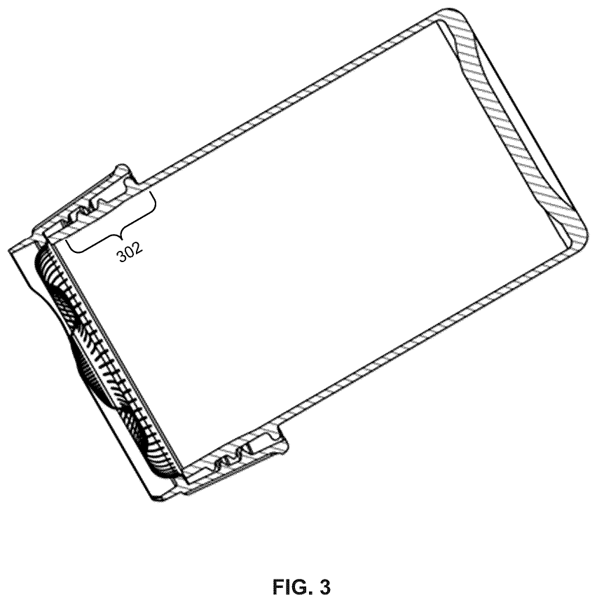

FIG. 3 is a diagram showing a cross-section of a container, a porous filter, and a collar of the integrated sprouter device in accordance with some embodiments. For example, the cross-section shown in FIG. 3 is a cross-section down the center of the combined container, a porous filter, and a collar that is shown in FIG. 2. The cross-sectional view of FIG. 3 shows that the collar is coupled to the container by virtue of being engaged with threading 302 along the exterior surface of the container. In the example of FIG. 3, the interior surface of the collar includes threading features that can be coupled with the threading features along the exterior surface of the container such that the collar can be engaged with and disengaged from the container by twisting in a first direction or an opposite direction.

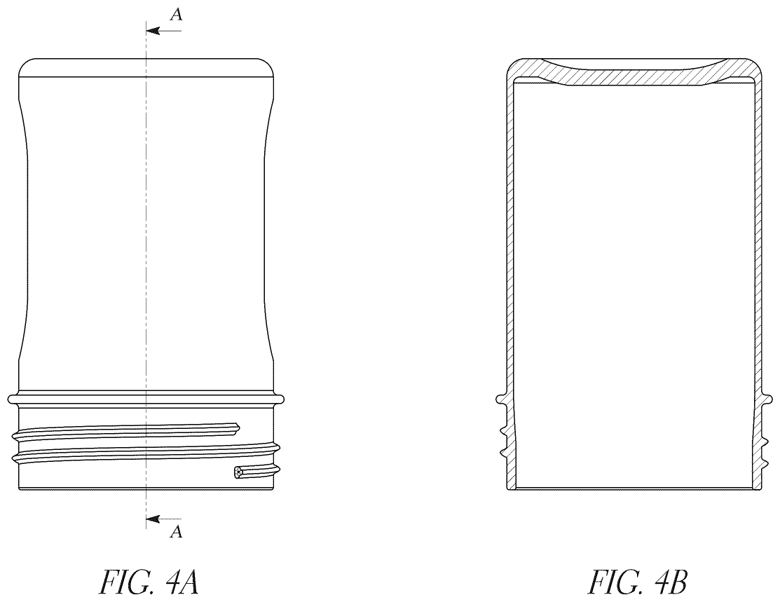

FIGS. 4A and 4B are diagrams of two views of the container of the integrated sprouter device in accordance with some embodiments. FIG. 4A shows the exterior surface of the container and highlights that, in some embodiments, the container is substantially a straight cylinder. Put another way, in some embodiments, the container is straight-walled with no narrowed neck near its open end. In contrast, conventional jars are narrower near the mouth. By utilizing a straight-walled design, the water will fully evacuate the container through the filter and there will be no pockets within the container in which water can be trapped. Another advantage of the straight-walled container is that sprouts are able to lay more flat inside the container, which improves air exchange within the mass of sprouts. Yet another advantage of the straight-walled container is that a user is more easily able to reach inside the jar to remove the sprouts at harvest time. While not shown in the example of FIG. 4A, in some embodiments, the container includes large indents that provide grip to a user in holding the container. In various embodiments, the container can be made of glass. In some embodiments, the container is 3 to 9 inches in length and has a diameter of 3 to 6 inches. FIG. 4A also shows another example of the threading features near its open end. FIG. 4B shows a cross-sectional view of the straight-walled container example.

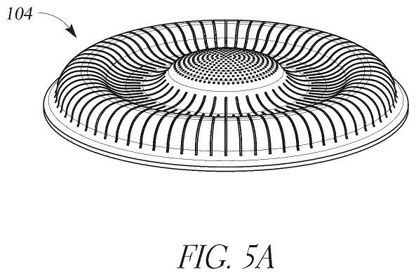

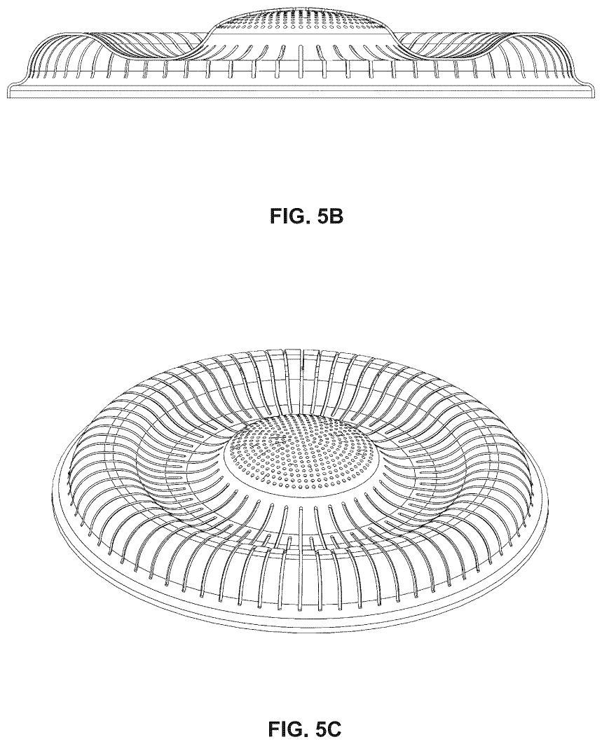

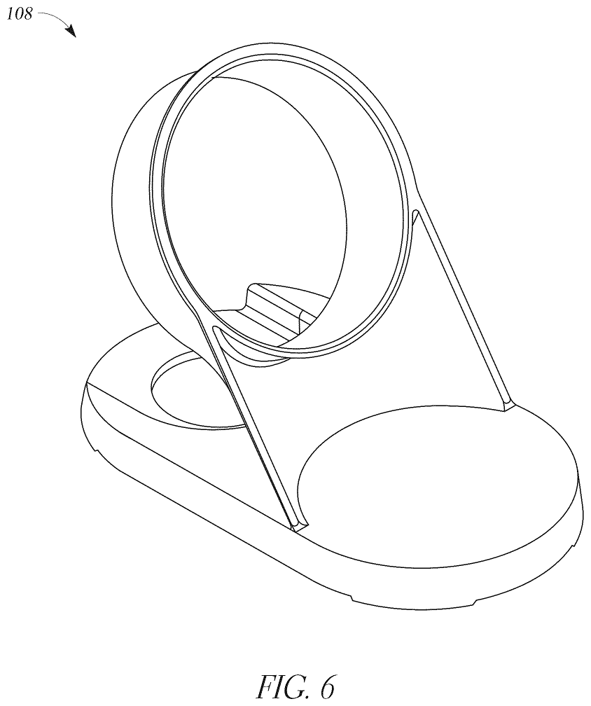

FIG. 5A is a diagram showing an example porous filter in accordance with some embodiments. In some embodiments, porous filter 104 of FIG. 1 may be implemented using the example porous filter of FIG. 5A. In the example of FIG. 5A, the filter is perforated by slots. These slots are precisely positioned to be flush with the edge of the lip/open end of the container (not shown). The combination of the straight-walled container and the filter with slots/pores that are flush with the lip of the open end of the contains allows water to fully drain/evacuate out of the container without obstruction. The collar (not shown) clamps the edge of the porous filter against the lip of the open end of the container in a manner that does not obstruct any water flow. The porous filter is shaped to draw water away from the surface of the filter. In some embodiments, the perforated filter is three-dimensionally formed, not flat. This three-dimensional (contoured) design reduces water from splashing during rinsing. For example, during the sprouting cycle, the user may turn the end of the container that is covered by the porous filter upwards to pour water into the container through the filter to rinse the seeds/sprouts within. The three-dimensional (contoured) design also optimizes airflow in and out of the container by providing a greater surface area. In various embodiments, the porous filter is made of metal (e.g., aluminum, stainless steel). While the example porous filter of FIG. 5A shows a three-dimensional (contoured) design, in some other embodiments, the porous filter may not be contoured. In some embodiments, as shown in FIG. 5B and FIG. 5C, the porous filter may have a flange or lip that extends parallel with the wall of the container. This feature engages with the rim of the jar, effectively centering the filter and preventing it accidentally being knocked off when screwing the “collar” on.

FIG. 6 is a diagram showing an example of a stand of an integrated sprouter device in accordance with some embodiments. In the example of FIG. 6, the stand is shown without an inserted container or a water capture tray in its cavity. As shown in FIG. 6, the base of the stand is wide enough such that the stand does not tip over due to the weight of an inserted container. In one specific example, the stand is 10 inches in depth, 6 inches in width, and 8 inches in height. In some other embodiments, multiple stands could stack together to create tiered units (“multi-sprouter stands”) and such stacked units could have smaller dimensions. While not visible in FIG. 6, the bottom surface of the base of the stand that interfaces with a plane on which the base will rest includes one or more rubber feet that are positioned in such a manner and shape to reduce the ability of the stand to slide forward/backward during use. The feet feature parallel fins can deform against, for example, a countertop surface and increase the friction between the stand and that surface, which will increase the stability of the stand with or within an inserted container.

In some other embodiments, the stand includes more than one arm and where each arm includes an opening through which a respective container can be inserted such that the stand could hold multiple containers. In some other embodiments, the arm comprises a wedge or a cradle that instead of including a circular/ring-shaped opening through which the container can be inserted, includes a half circle (e.g., groove or recess) on which to rest the container.

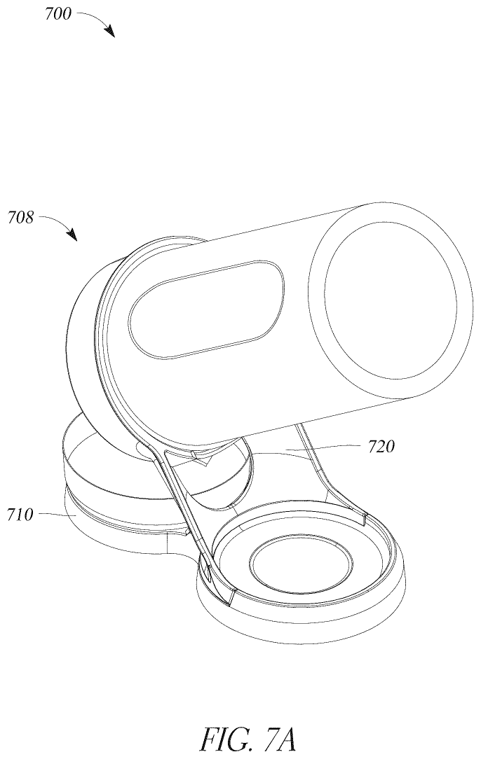

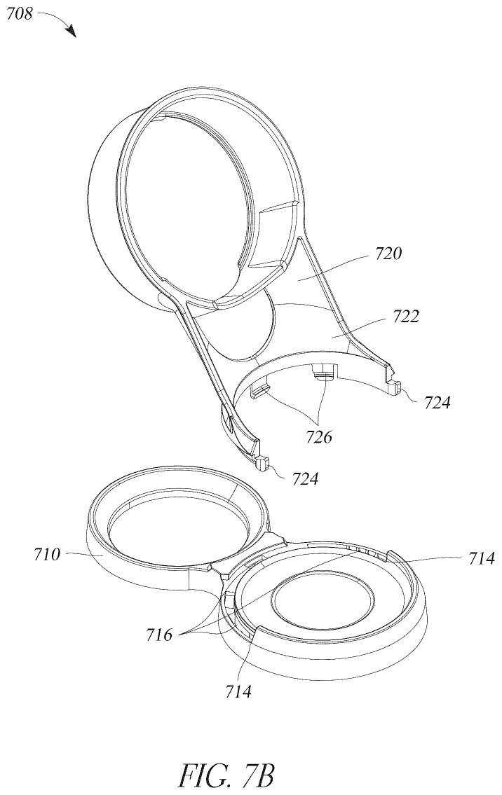

FIG. 7A is a perspective view of an integrated sprouter device 700 according to another embodiment. Any embodiments of the integrated sprouter device 700 described herein may include the same or similar features and/or functions as other integrated sprouter devices described herein, such as those shown in and described with respect to FIGS. 1-6, and vice versa. Any of the other features described herein for integrated sprouter devices or components thereof may be used with the systems, devices, and methods described with respect to FIGS. 7-13C, and vice versa. The integrated sprouter device 700, or any of the integrated sprouter devices disclosed herein, may be referred to as an analog sprouter device. The integrated sprouter device 700 may include a stand 708, which may be similar to the stand 108. The stand 708 may include a base 710, which may be the same as or similar to the base 108b, and an arm 720, which may be the same as or similar to the arm 108a. The stand 708 may include one or more of metal, polymers, glass, ceramics, composites, natural materials, and/or any combination thereof. For example and without limitation, the stand 708 may include 30% glass-filled acrylonitrile butadiene styrene (ABS).

FIG. 7B is a perspective view of the stand 708 of FIG. 7A, with the arm 720 separated from the base 710. The arm 720 may be removably couplable to the base 710. Separating the arm 720 from the base 710 may allow the stand 708 to be stored compactly, for example during shipping, and may allow the arm 720 and/or the base 710 to be changed or replaced. The arm 720 and the base 710 may include a coupling mechanism such that the arm 720 may be coupled to and removed from the base 710. The coupling mechanism may include any mechanical coupling mechanism, such as but not limited to a snap mechanism, threading, an interference or friction fit, one or more bolts, one or more threaded inserts, one or more straps, or any other coupling mechanism, or any combination thereof. For example, as shown in FIG. 7B, the arm 720 and the base 710 may include a hinge and snap mechanism which may allow the arm 720 to be coupled to and decoupled from the base 710. A proximal end 722 of the arm 720 may include one or more tabs 724 and one or more male snap joint features 726. The base 710 may include one or more slots 714 which may receive the one or more tabs 724 of the arm 720, and one or more female snap joint features 716, which may engage with the one or more male snap joint features 726 of the arm 720.

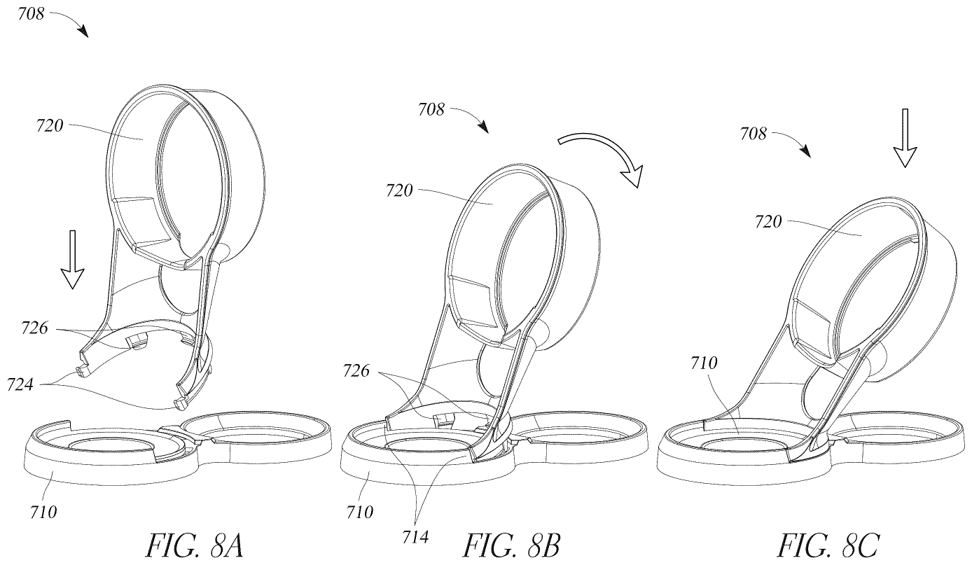

FIGS. 8A-8C are perspective views of the stand 708 of FIGS. 7A-7B being assembled. FIG. 8A shows the arm 720 separated from the base 710. As shown in FIG. 8A, the arm 720 may be moved downwards (as oriented in the figure) towards the base 710. FIG. 8B shows the arm 720 being coupled to the base 710. The one or more tabs 724 may be positioned within the one or more slots 714 of the base 710, as shown. The arm 720 may be rotated backwards (as oriented in the figure) to move the one or more male snap joint features 726 of the arm 720 towards the one or more female snap joint features 716 of the base 710. FIG. 8C shows the assembled stand 708. The one or more male snap joint features 726 may be moved downwards (as oriented in the figure) to engage the one or more female snap joint features 716 of the base 710. The one or more male snap joint features 726 and the one or more female snap joint features 716 may snap together to couple the arm 720 to the base 710. While a hinge and snap mechanism are shown in FIGS. 8A-8C, any coupling mechanism may be used to couple the arm 720 to the base 710.

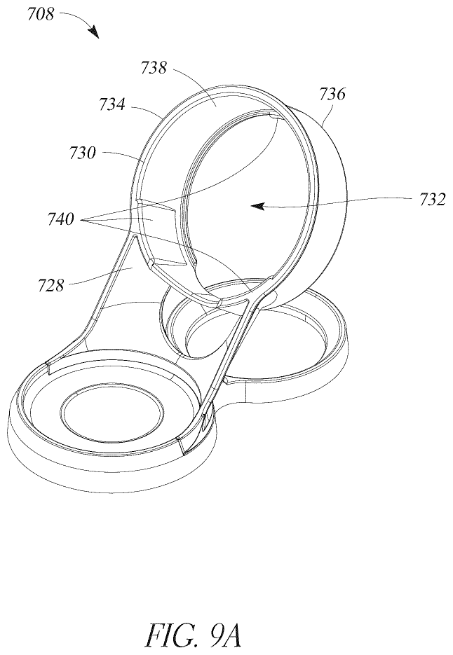

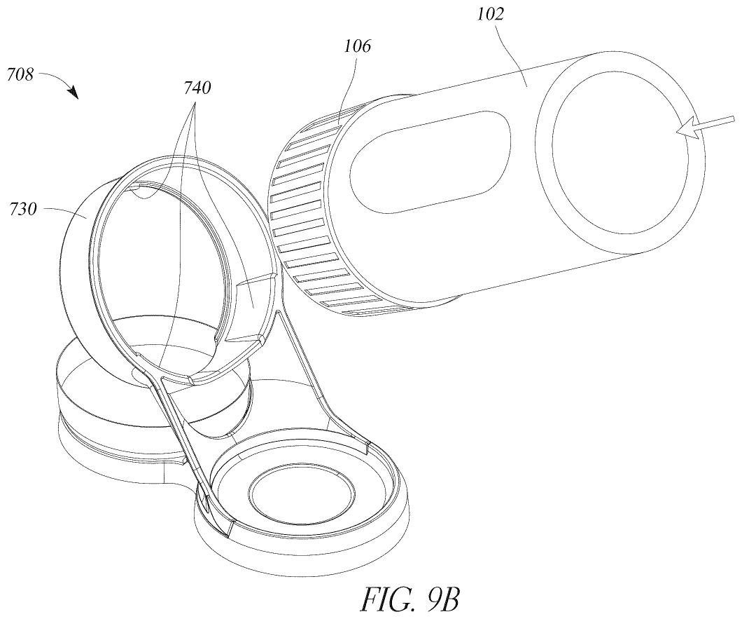

FIGS. 9A-9B are perspective views of the stand 708, which includes a receiver 730 at a distal end 728 of the arm 720 for receiving and supporting a container (e.g., container 102). FIG. 9A is a perspective view of the stand 708 without a container. FIG. 9B is a perspective view of the stand 708 with the container 102 being positioned therein. The receiver 730 may include an opening 732, which may be the same as or similar to the opening as described herein with respect to FIGS. 1-6. The receiver 730 may have a ring shape defining the opening 732. The container 102 may be positioned within the opening 732 of the receiver 730, and suspended above a drip tray. In other embodiments, the receiver 730 may have any other shape, and/or may include a recess, a wedge, a cradle, and/or a half-circle which may receive the container 102. The receiver 730 may include a proximal edge 734, a distal edge 736, and a wall 738 extending between the proximal edge 734 and the distal edge 736, which may define the opening 732. The wall 738 may have a length (e.g., the distance between the proximal edge 734 and the distal edge 736) that is approximately ⅛ the perimeter of the proximal edge 734, or from approximately 1/10 to approximately ¼ the perimeter of the proximal edge 734, or from approximately 1/16 to approximately ½ the perimeter of the proximal edge 734, or any value, approximate value, or range of values within the foregoing ranges. The receiver 730 may include one or more contacts 740 positioned within an interior of the wall 738. For example, as shown in FIGS. 9A-9B, the receiver 730 may include three contacts 740. The one or more contacts 740 may be protrusions that extend radially inward from the receiver 730, into the opening 732, to contact and support the container 102 and/or the collar 106. The one or more contacts 740 may hold and constrain the container 102 and/or the collar 106 within the receiver 730, which may prevent or reduce slipping or sagging of the container 102 and/or the collar 106 within the receiver 730. The receiver 730, and/or the one or more contacts 740 therein, may be sized, shaped, and/or positioned to support the container 102 and/or the collar 106 within the receiver 730 using a cantilever effect. For example, the one or more contacts 740 may be configured such that the container 102 and/or the collar 106 rests on two lower contacts of the one or more contacts 740, and an upper contact of the one or more contacts 740 engages with the container 102 and/or the collar 106 to secure the container 102 and/or the collar 106 within the receiver 730. In some embodiments, the one or more contacts 740 may be sized and/or positioned to provide a friction fit between the receiver 730 and the container 102 and/or the collar 106. The one or more contacts 740 may create an amount of friction as to secure the container 102 and/or the collar 106 while still allowing container 102 and/or the collar 106 to be easily removed from the stand 708. For example, a user may want to rotate the container 102 and/or the collar 206 within the receiver 730 of the stand 708 to distribute seeds/sprouts within the container 102 and/or to release more water from the container 102 into the capture tray. In some embodiments, as shown in FIG. 9A, the one or more contacts 740 may extend from the proximal edge 734 of the receiver 730 towards the distal edge 736 of the receiver 730. For example, the one or more contacts 740 may extend along an interior of the wall 738 more than 50% of the distance between the proximal edge 734 and the distal edge 736, or more than 75%, or more than 90%, or any percentage, approximate percentage, or range of percentages within the foregoing percentages, as shown by the lower two contacts of the one or more contacts 740, as oriented in FIG. 9B. In some embodiments, the one or more contacts 740 may taper along their lengths. For example, the one or more contacts 740 may taper in a direction from a proximal edge 734 towards the distal edge 736, as shown by the lower two of the one or more contacts 740, as oriented in FIG. 9B. In some embodiments, the one or more contacts 740 may taper in the direction of the distal edge 736 towards the proximal edge 734. In some embodiments, the one or more contacts 740 may not extend along a length of the inner surface of the wall 738. For example, as shown in FIG. 9B, the upper contact of the one or more contacts 740 extends radially inwards from the distal edge 736, but does not extend along the length of the wall 738 between the distal edge 736 and the proximal edge 734, or does so only a small amount (e.g., less than 20% of the distance between the distal edge 736 and the proximal edge 734, or less than 10%, or less than 5%). The one or more contacts 740 may have widths, as measured along the perimeter of the receiver 730, of approximately ⅛ of the perimeter of the receiver 730 (e.g., the perimeter of the proximal edge 734), or from approximately 1/12 of the perimeter of the receiver 730 to approximately ⅙ of the perimeter of the receiver 730, or from approximately 1/16 of the perimeter of the receiver 730 to approximately ¼ of the perimeter of the receiver 730, or any value, approximate value, or range of values within the foregoing ranges. In some embodiments, the perimeter of the proximal edge 734 may be the equal to the perimeter of the distal edge 736. In some embodiments, the perimeter of the proximal edge 734 may be greater than the perimeter of distal edge 736. While FIG. 7A illustrates a receiver 730 having three contacts 740, any number of contacts 740 may be included. For example, the receiver 730 may include one, two, three, four, five, six, seven, eight, or more than eight, or any number of contacts.

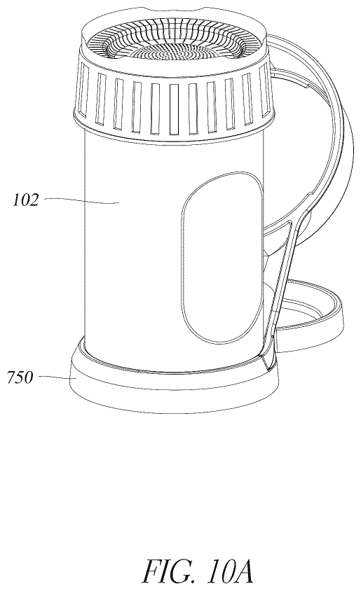

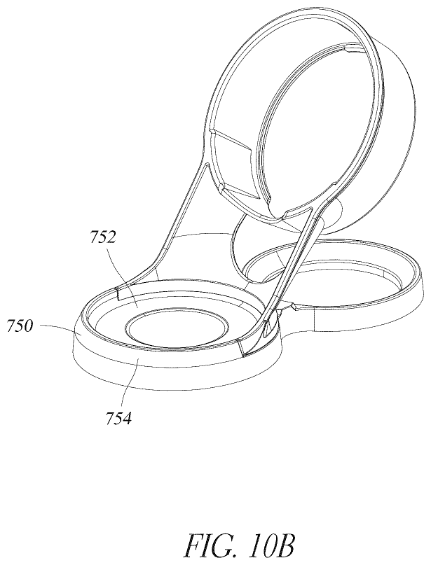

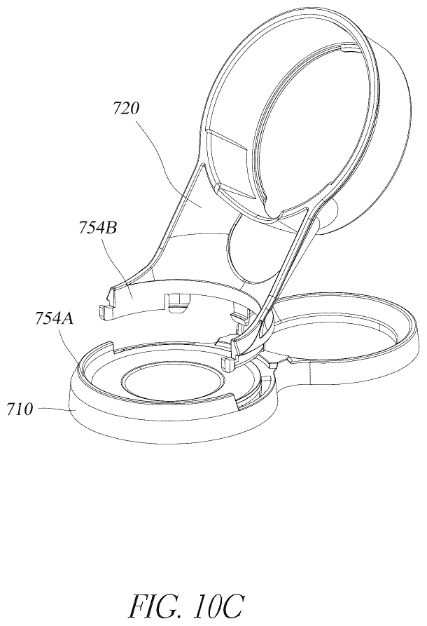

FIGS. 10A-10C are perspective views of the stand 708, which includes a docking area 750. FIG. 10A is a perspective view of the stand 708 with the container 102 positioned on the docking area 750 of the stand 708. The docking area 750 may be a portion of the stand 708 on which the container 102 may be positioned in an upright or substantially upright position. For example, the container 102 may be positioned on the docking area 750 during a soaking stage.

FIG. 10B is a perspective view of the stand 708 without a container positioned on the docking area 750. The docking area 750 may include a surface 752 which may be flat or substantially flat, and which may receive the bottom (e.g., the closed end) of the container 102. In some embodiments, the surface 752 may include text, which may be embossed or debossed, and which may be for branding, instructions, or other purposes. The docking area 750 may include a rim 754 which may partially or fully surround the container 102 when the container 102 is positioned on the docking area 750. The rim 754 may be a circular wall that may extend parallel or substantially parallel to the wall of the container 102 when the container 102 is positioned on the docking area 750. The rim 754 may prevent or limit the container 102 from sliding off of the docking area 750.

FIG. 10C is a perspective view of the stand 708 with the arm 720 separated from the base 710. As shown in FIG. 10C, the rim 754 of the docking area 750 may be defined at least partially by the arm 720 and at least partially by the base 710. For example, the base 710 may include a first portion 754A of the rim 754, and the arm 720 may include a second portion 754B of the rim 754. When the arm 720 is coupled to the base 710, the first portion 754A of the rim 754 and the second portion 754B of the rim 754 may be aligned with each other to form the rim 754, and may prevent or limit the container 102 from sliding off the docking area 750.

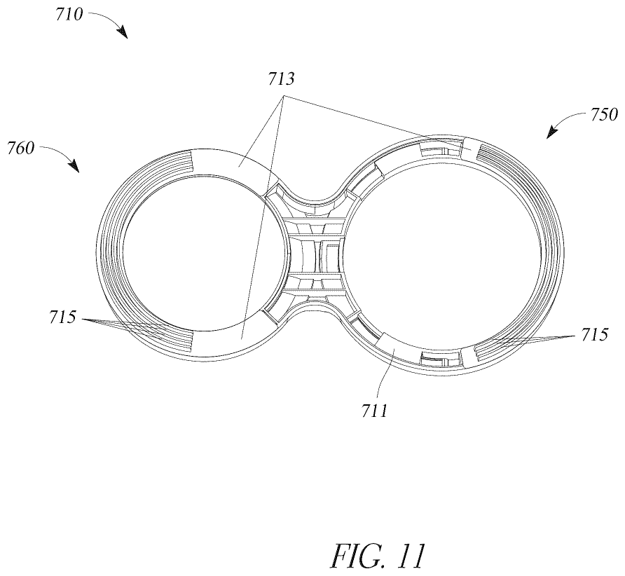

FIG. 11 is a lower end view of the base 710 of the stand 708. The bottom 711 of the base 710 of the stand 708, which may interface with a surface on which the stand 708 may rest, may include one or more feet 713 that may reduce the ability of the stand 708 to slide during use. The one or more feet 713 may include one or more fins 715 that may deform against the surface (e.g., a countertop surface) and increase the friction between the stand and the surface, which will increase the stability of the stand with or within an inserted container. The one or more fins 715 may include a plurality of elongated fins extending from the one or more feet 713 towards the surface on which the stand 708 may be positioned (e.g., a countertop). The one or more fins 715 may support the stand 708 when the stand 708 rests on the surface (e.g., a countertop). In some embodiments, the one or more fins 715 may curve around all or a portion of the bottom surface of the docking area 750 and/or the bottom surface of the capture tray area 760, as shown in FIG. 11.

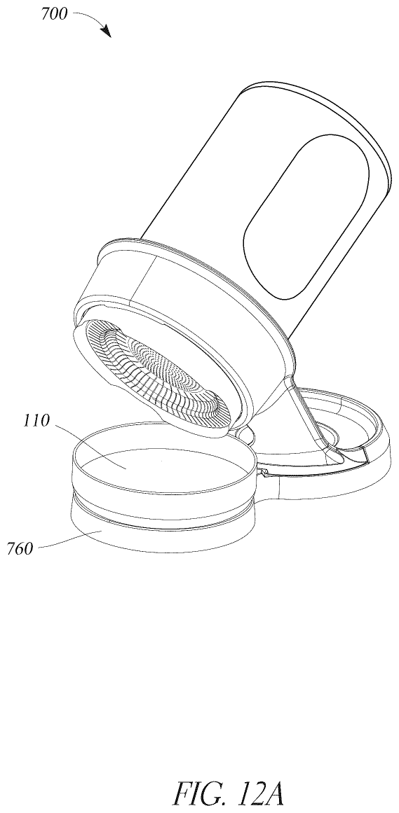

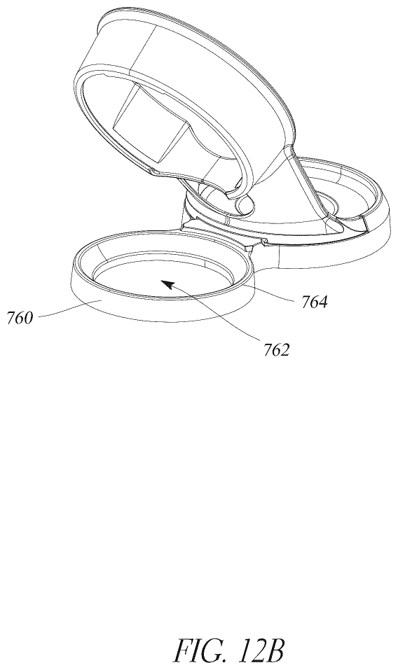

FIG. 12A is a perspective view of the stand 708 with a capture tray 110 positioned thereon. In some embodiments, the capture tray 110 may include metal (e.g., aluminum, stainless steel), plastic, glass, silicone, rubber, or other materials, or any combination thereof. The capture tray 110 may have a volume of approximately 350 milliliters (mL), or from approximately 300 mL to approximately 400 mL, or from approximately 200 mL to approximately 500 mL, or less than 200 mL, or greater than 500 mL, or any value, approximate value, or range of values within the foregoing ranges. The capture tray 110 may be positioned on a capture tray area 760 of the stand 708.

FIG. 12B is a perspective view of the stand 708 without the capture tray 110 positioned thereon. The stand 708 may include a capture tray area 760, which may receive the capture tray 110. As shown in FIG. 12B, the capture tray area 760 may include an opening 762, which may be a through-hole through the base 710, in which the capture tray 110 may be positioned. In some embodiments, the capture tray area 760 may include a flat or substantially flat surface on which the capture tray 110 may be positioned. The capture tray area 760 may include a rim 764 which may partially or fully surround the capture tray 110 when the capture tray 110 is positioned on the capture tray area 760. The rim 764 may be a circular wall that may extend parallel or substantially parallel to the wall of the capture tray 110 when the capture tray 110 is positioned on the capture tray area 760. The rim 764 may prevent or limit the capture tray 110 from sliding off of the capture tray area 760. The capture tray area 760 may be positioned such that the capture tray 110 can receive fluid from the container 102 when the container 102 is positioned within the receiver 730 of the arm 720. The capture tray area 760 may be positioned such that such that the arm 720 suspends the opening of the container 102 above the capture tray 110 when the capture tray 110 is positioned on the capture tray area 760.

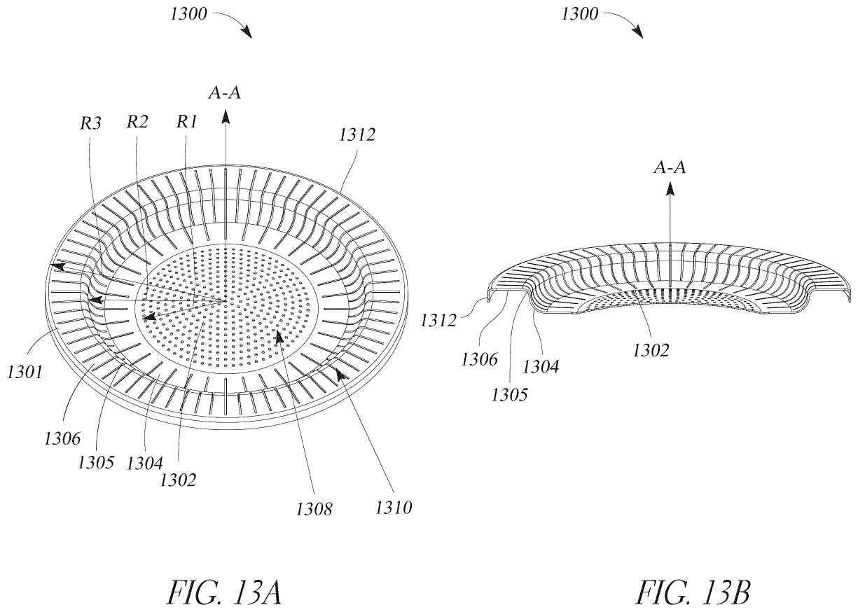

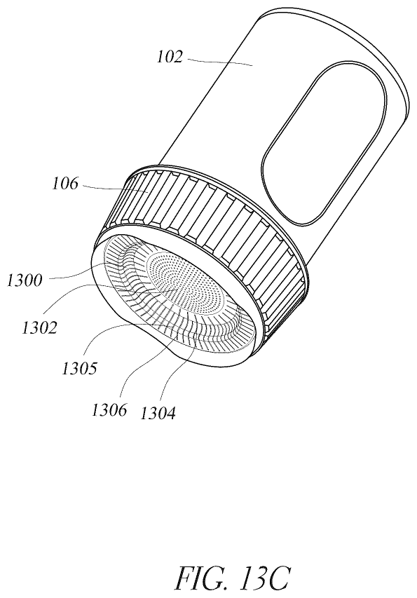

FIG. 13A is a perspective view of another embodiment of a porous filter 1300, which may be similar to the porous filter 104, and may have any of the same features and/or functions, and vice versa. FIG. 13B is a side, section view of the porous filter 1300 of FIG. 13A. The porous filter 1300 may be shaped to improve fluid flow into and/or out of the container 102. The porous filter 1300 may include a central portion 1302, a first annular region 1304 around the central portion 1302, and a second annular region 1306 around the first annular region 1304. The central portion 1302 may have a radius R1 from a central axis A-A of the porous filter 1300. The first annular region may be defined between radius R1 and radius R2, as shown in FIG. 13A. The second annular region 1306 may be defined between radius R3 and radius R2, as shown in FIG. 13A. The central portion 1302 may include a plurality of holes 1308 (e.g., pores) therethrough. In some embodiments, as shown in FIG. 13A, the plurality of holes 1308 may be arranged in a plurality of rows positioned radially around the center of the central portion 1302. On a front side 1301 of the porous filter 1300, the central portion 1302 may have a convex curvature, as shown in FIGS. 13A-13C. On the front side 1301, the first annular region 1304 may have a concave curvature, as shown in FIGS. 13A-13C. On the front side 1301, the second annular region 1306 may be flat, as shown in FIGS. 13A-13C. In some embodiments, on the front side 1301, the second annular region 1306 may have a convex curvature. The porous filter 1300 may include a flange 1312 at the radius R3 that may extend around the lip of the container 102 and parallel or substantially parallel to the wall of the container 102 when the porous filter 1300 is positioned over the container 102. The flange 1312 may engage with the lip of the container 102, effectively centering the porous filter 1300 over the container 102 and preventing the porous filter 1300 from accidentally being knocked off of the container 102 when coupling the collar 106 to the container 102. The porous filter 1300 may include a plurality of slots 1310 extending radially outwards, as shown in FIG. 13A. The plurality of slots 1310 may be positioned to be flush with the edge of the lip or open end of the container 102. In some embodiments, as shown in FIG. 13A, the plurality of slots may extend from the first annular region 1304 to the second annular region 1306. In some embodiments, as shown in FIG. 13A, the plurality of slots may alternate in length (e.g., first length, second length, first length, second length, etc.). As shown in FIG. 13A, the radially outer ends of the plurality of slots 1310 may be aligned with each other, and the radially inner ends of the plurality of slots 1310 may alternate in radial position (e.g., radially outward, radially inward, radially outward, radially inward, etc.). The first annular region 1304 and the second annular region 1306 may meet at an edge 1305. The edge 1305 may be positioned at the radius R2 from the central axis A-A of the porous filter 1300. In some embodiments, the first annular region 1304 and the second annular region 1306 may meet at the edge 1305 at approximately 90 degrees, or from approximately 80 degrees to approximately 100 degrees, or from approximately 70 degrees to approximately 110 degrees, or any value, approximate value, or range of values within the foregoing ranges. In some embodiments, the central portion 1302 may be recessed relative to the second annular region 1306. For example, the central portion 1302 may extend to a height along the central axis A-A that is shorter than, or the same as, the height of the second annular region 1306 along the central axis A-A.

FIG. 13C is a perspective view of the porous filter 1300 positioned on the container 102. As described herein with respect to FIGS. 1-6, the collar 106 may couple to the container 102. The porous filter 1300 may be positioned between the collar 106 and the container 102. The flange 1312 of the porous filter 1300 may be positioned around the lip of the container 102, which may help the porous filter 1300 to remain aligned on the container 102. The collar 106 may clamp the porous filter 1300 against the lip of the open end of the container 102 in a manner that does not obstruct any water flow out of the container 102 when the container 102 is positioned within the stand 708. In some embodiments, as shown in FIG. 13C, the second annular region 1306 may be perpendicular or substantially perpendicular to the wall of the container 102 when the porous filter 1300 is coupled to the container 102. As shown in FIG. 13C, the central portion 1302 of the porous filter may be recessed relative to the second annular region 1306. The shape of the porous filter 1300 improves the flow of fluid into and out of the container 102. The central portion 1302 being recessed relative to the second annular region 1306 can allow air to escape from the interior of the container 102 through the plurality of slots 1310 while fluid (e.g., water) is being poured into the container 102 through plurality of holes 1308 of the central portion 1302 of the porous filter 1300. In flat filters, the fluid often spreads across the surface of the filter while the fluid is being poured into the container 102, effectively sealing the filter and restricting the flow of air out of the container 102. Additionally, the plurality of slots 1310 may be positioned such that they are flush with the edge of the lip or open end of the container 102, such that the ends of the plurality of slots 1310 do not obstruct the flow of fluid (e.g., water) out of the container 102.

The stand 700 as shown in and described with respect to FIGS. 7A-12B may provide many advantages. For example, the two-part design of the stand 708, in which the arm 720 can be separated from the base 710, may allow the stand 708 to be stored more compactly. The stand 708 may allow for 50% smaller product packaging than the stand 108 as shown in and described with respect to FIGS. 1 and 6. The stand 708 may include a hinge and snap mechanism to allow the arm 720 and the base 710 to easily couple and decouple from each other, and to provide a simple and sturdy fit. The stand 708 may include one or more contacts 740 within the receiver 730, which may hold and constrain the container 102 to provide improved stability to the container 102 when the container 102 is positioned within the receiver 730, and to prevent sagging of the container 102 within the receiver 730. The stand 708 may include larger feet 713 as compared to the stand 108 as shown in and described with respect to FIGS. 1 and 6, which may provide improved stability of the stand 708 as the container 102 is moved into and out of the stand 708. The stand 708 may include a docking area 750 having a surface 752 on which the container 102 may be positioned in an upright or substantially upright position, and a rim 754 which may prevent or limit the container 102 from sliding off of the docking area 750. The stand 708 may include a capture tray area 760 to receive a capture tray 110, where the capture tray area 760 may include a rim 764 to prevent or limit the capture tray 110 from sliding off of the capture tray area 760. The bottom 711 of the base 710 of the stand 708 may have a smaller surface area than the bottom of the stand 108, which may allow the stand 708 to occupy less space on the surface on which the stand 708 is positioned, and which may reduce manufacturing costs. The porous filter 1300 as shown in and described with respect to FIGS. 13A-13C may provide many advantages. For example, the porous filter 1300 may provide advantages over the porous filter 104 as shown in and described with respect to FIGS. 1-5C. The porous filter 1300 as shown in and described with respect to FIGS. 13A-13C may allow for faster fluid flow when filling and draining the container 102 with fluid (e.g., water). The design of the porous filter 1300 is the result of extensive testing and development effort. The shape of the porous filter 1300 and the arrangement of the plurality of holes 1308 and the plurality of slots 1310 provide improved water flow into and out of the container 102. The plurality of slots 1310 may be flush with the lip of the container 102 when the porous filter 1300 is positioned over the container 102 to allow fluid to flow out of the container 102 through the porous filter 102 without obstructing flow.

Although the foregoing embodiments have been described in some detail for purposes of clarity of understanding, the present disclosure is not limited to the details provided. There are many alternative ways of implementing the present disclosure. The disclosed embodiments are illustrative and not restrictive. While certain embodiments have been described, these embodiments have been presented by way of example only, and are not intended to limit the scope of the disclosure. Indeed, the novel methods and systems described herein may be embodied in a variety of other forms. Furthermore, various omissions, substitutions and changes in the systems and methods described herein may be made without departing from the spirit of the disclosure. The accompanying claims and their equivalents are intended to cover such forms or modifications as would fall within the scope and spirit of the disclosure.

Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some embodiments, the actual steps taken in the processes illustrated and/or disclosed may differ from those shown in the figures. Depending on the embodiment, certain of the steps described above may be removed, others may be added. Furthermore, the features and attributes of the specific embodiments disclosed above may be combined in different ways to form additional embodiments, all of which fall within the scope of the present disclosure. Also, the separation of various system components in the implementations described above should not be understood as requiring such separation in all implementations, and it should be understood that the described components and systems can generally be integrated together in a single product or packaged into multiple products. For example, any of the components for an integrated sprouter device described herein can be provided separately, or together (e.g., packaged together, or attached together) to form an integrated sprouter device.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result.

The scope of the present disclosure is not intended to be limited by the specific disclosures of preferred embodiments in this section or elsewhere in this specification, and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

What is claimed is:

1. A sprouter device comprising:
a stand comprising:
a base;
an arm comprising a proximal end and a distal end, the proximal end of the arm configured to be coupled to the base; and
a receiver at the distal end of the arm, the receiver configured to receive a container.

2. The sprouter device of claim 1, wherein the arm is configured to be coupled to the base via a hinge and snap mechanism.

3. The sprouter device of claim 2, wherein the proximal end of the arm comprises a plurality of male snap joint features, and the base comprises a plurality of female snap joint features configured to engage with the plurality of male snap joint features of the arm.

4. The sprouter device of claim 3, wherein the proximal end of the arm comprises a plurality of tabs, and the base comprises a plurality of slots configured to receive the plurality of tabs of the arm.

5. The sprouter device of claim 1, wherein the receiver comprises a ring.

6. The sprouter device of claim 5, wherein the receiver comprises a plurality of contacts positioned within an interior of the ring, the plurality of contacts configured to contact the container when the container is positioned within the receiver.

7. The sprouter device of claim 6, wherein one or more of the plurality of contacts extend along an interior of a wall of the receiver.

8. The sprouter device of claim 6, wherein one or more of the plurality of contacts taper along an interior of a wall of the receiver.

9. The sprouter device of claim 1, wherein the base comprises a docking area configured to receive the container.

10. The sprouter device of claim 9, wherein the docking area comprises a rim configured to extend at least partially around the container when the container is positioned on the docking area.

11. The sprouter device of claim 10, wherein the arm comprises a first portion of the rim and the base comprises a second portion of the rim.

12. The sprouter device of claim 1, wherein the base comprises a docking area and a capture tray area, and a bottom of the base comprises a first plurality of fins extending around a bottom of the docking area and a second plurality of fins extending around a bottom of the capture tray area.

13. The sprouter device of claim 1, wherein the base comprises a capture tray area configured to receive a capture tray.

14. The sprouter device of claim 13, wherein the capture tray area is configured to receive the capture tray such that the arm suspends the container above the capture tray when the container is positioned within the receiver of the arm.

15. The sprouter device of claim 13, wherein the capture tray area comprises a through-hole through the base.

16. The sprouter device of claim 13, wherein the capture tray area comprises a rim configured to extend at least partially around the capture tray when the capture tray is positioned on the capture tray area.

17. The sprouter device of claim 1, wherein the stand comprises 30% glass-filled ABS material.

18. The sprouter device of claim 1, further comprising a capture tray, wherein the capture tray comprises a volume of approximately 350 mL.

19. The sprouter device of claim 1, further comprising:
a container configured to be positioned within the stand; and
a porous filter configured to be positioned over an open end of the container, wherein the porous filter comprises a plurality of holes on a central portion of the porous filter and a plurality of slots extending radially outwards.

20. The sprouter device of claim 19, wherein the porous filter comprises a first annular region surrounding the central portion and a second annular region surrounding the first annular region, and wherein the central portion is convex, the first annular region is concave, and the second annular region is flat.
